(19) United States
(12) Patent Application Publication
(10) Pub. No.: US 2026/0228425 A1
(43) Pub. Date: Aug. 6, 2026

(54) COMPUTER-IMPLEMENTED SYSTEM AND METHOD FOR DYNAMICALLY SELECTING A LANGUAGE MODEL TO PROCESS QUERIES

(71) Applicants: Honish Joseph, Mountain House, CA (US); Balasubramanian Purushothaman, Livermore, CA (US)

(72) Inventors: Honish Joseph, Mountain House, CA (US); Balasubramanian Purushothaman, Livermore, CA (US)

(21) Appl. No.: 19/043,410

(22) Filed: Jan. 31, 2025

(51) Int. Cl. G06F 40/20; G06F 16/383

(52) U.S. Cl. CPC G06F 40/20; G06F 16/383

(57) ABSTRACT

Disclosed is a computer-implemented system and method for dynamically selecting and querying large language models (LLMs) to generate contextually relevant and accurate responses. The method includes receiving a query, a set of signals, and a set of parameters along with specific real-time indicators such as user attributes. Based on the query, signals, and parameters the system determines a suitable LLM from a set of models using predefined rules, machine learning algorithms, and runtime signals. The selected LLM is queried to generate a set of responses, which are weighted and ranked based on the signals. The method resolves inconsistencies among responses and produces a consolidated response tailored to the query. This approach enhances personalization and contextual accuracy in LLM-based outputs, addressing the limitations of conventional query-processing systems.

### FIELD OF INVENTION

The disclosure relates to data processing and more particularly, to computer-implemented systems and methods for dynamically selecting a language model to process one or more queries.

### BACKGROUND

Large Language Models (LLMs) are extensively used in artificial intelligence (AI) systems to generate contextually relevant responses to user queries. These queries can be input through either a voice-based interface or a graphical user interface. A primary function of an LLM is to understand the user's question and infer its context to produce an appropriate and accurate answer.

Although LLMs are effective at interpreting and responding to queries, their performance can be significantly enhanced by dynamically adapting their operations based on additional contextual signals. Current AI systems typically rely solely on the content of the query for processing and often overlook supplemental factors, such as user-specific attributes (e.g., age, location, or browsing history) and runtime conditions (e.g., regional news trends or real-time events). This limitation can result in generic responses that may not fully meet the user's needs or preferences.

Chinese patent application CN118193714A, published by Li Rui et al., discloses a dynamic adaptation question-answering system and method based on a hierarchical structure and retrieval enhancement. This invention belongs to the field of artificial intelligence and includes a knowledge representation module, a retrieval enhancement generation module, a dynamic learning and adaptation module, a cross-domain knowledge integration module, a user interaction module, and an evaluation and optimization module. The system introduces a hierarchical structure to represent relationships among entities within an organization, improving the utilization of knowledge structures. By integrating Retrieval-Augmented Generation (RAG) technology with fine-tuned LLMs and LRAG systems, the invention enhances the accuracy of questions and answers, supports dynamic learning and adaptation, and facilitates cross-domain knowledge integration. It offers an efficient solution for document querying and answering within organizations, enabling effective knowledge management and continuous query optimization over time. However, this patent application is limited to knowledge management and document querying within organizations.

Further, Chinese patent application CN117951274A, published by Zhang Jinlin et al., discloses an RAG-based knowledge question-answering method and device that utilizes fusion vectors and keyword retrieval. This method enables user question-answering using a constructed knowledge base. A vector embedding model generates a vector value (QE1) for a given question (Q1), retrieves semantically similar text paragraphs (PK1) from a vector database, and retrieves additional high-scoring text paragraphs (PK2) using a search engine. The combined text arrays (Mix-PK) and the question form a prompt text (Prompt1), which is processed by the LLM to generate an answer. This approach maintains the advantages of high universality and low cost while significantly improving retrieval recall and accuracy rates in practical scenarios. This Chinese patent application is about question-answering systems using a constructed knowledge base. Thus, the existing prior arts focus on retrieval enhancements and knowledge representation rather than dynamically switching between multiple LLMs.

There remains a need for a system and method capable of dynamically switching between multiple LLMs during query processing. Additionally, there is a need for a system that incorporates user-specific signals and runtime indicators to select the most suitable LLM or combination of LLMs, thereby generating accurate and contextually enriched responses. Such a dynamic switching mechanism can enhance personalization and relevance in AI-generated outputs, addressing the limitations of existing systems.

### SUMMARY

According to an embodiment of the disclosure, a computer-implemented method for dynamically selecting a language model to process one or more queries is described. The computer-implemented method includes receiving, by a computer, a query, a set of signals, and a set of parameters associated with the query. The computer-implemented method further includes based on the query, the set of signals, and the set of parameters determining, by the computer, which of a set of language models is suitable for generating a response. The computer-implemented method further includes selecting, by the computer, at least one of a large language model from the determined set of language models based on a set of predefined rules, a set of machine learning models, and a set of real-time signals. The computer-implemented method further includes querying, by the computer, at least one of the large language models to generate a set of responses based on the selected large language model. The computer-implemented method further includes applying, by the computer, a weightage to the set of responses based on the set of signals and the set of parameters, wherein the set of parameters is included in signals. The computer-implemented method further includes determining, by the computer, one or more inconsistencies among the responses to generate a consolidated response. The computer-implemented method further includes outputting, by the computer, the consolidated response.

According to one or more embodiments of the disclosure, a computer system for dynamically selecting a language model to process one or more queries is described. The computer system includes a processor set, a computer-readable storage media, and program instructions that are stored on the one or more computer-readable storage media. The program instructions are executable by the processor set to cause the processor set to receive a query, a set of signals, and the set of parameters associated with the query. The program instructions further cause the processor set to determine, based on the query, the set of signals, and parameters which language model from the set of language models is suitable for generating a response. The program instructions further cause the processor set to select at least one of a large language model from the determined set of language models based on a set of predefined rules, a set of machine learning models, and a set of real-time signals and parameters. The program instructions further cause the processor set to querying at least one of the large language models to generate a set of responses based on the selected large language model. The program instructions further cause the processor set to apply a weightage to the set of responses based on the set of signals, and the set of parameters. The program instructions further cause the processor set to determine one or more inconsistencies among the responses to generate a consolidated response. The program instructions further cause the processor set to output the consolidated response.

According to one or more embodiments of the disclosure, a computer program product for dynamically selecting a language model to process one or more queries is described. The computer program product includes a computer-readable storage media having program instructions stored on the computer-readable storage media to perform operations. The operations include receiving one or more queries and a set of signals associated with the one or more queries. The operations further include based on the query and the set of signals, determining which of a set of language models is suitable for generating a response. The operations include selecting at least one of a large language model from the determined set of language models based on a set of predefined rules, a set of machine learning models, and a set of real-time signals. The operations include utilizing or querying at least one of the large language models to generate a response or a set of responses based on the selected large language model. The operations further include applying a weightage to the set of responses based on the set of signals and associated parameters. The operations further include determining one or more inconsistencies among the responses to generate a consolidated response. The operations further include outputting the consolidated response.

Additional technical features and benefits are realized through the process of the disclosure. Embodiments and aspects of the disclosure are described in detail herein and are considered a part of the claimed subject matter. For a better understanding, refer to the detailed description and the drawings.

### BRIEF DESCRIPTION OF THE DRAWINGS

The following description will provide details of preferred embodiments with reference to the following figures wherein:

FIG. 1 is a diagram that illustrates a computing environment for dynamically selecting a language model to process queries, in accordance with an embodiment of the disclosure;

FIG. 2 is a diagram that illustrates a network environment for dynamically selecting a language model to process queries, in accordance with an embodiment of the disclosure; and

FIG. 3 illustrates a flowchart that illustrates an exemplary computer-implemented method for dynamically selecting a language model to process queries, in accordance with an embodiment of the disclosure.

### DETAILED DESCRIPTION

The proposed computer system and method dynamically switch between large language models (LLMs) during query processing to generate responses that are both accurate and contextually relevant. The system incorporates additional signals with parameters alongside the user's query to determine the most suitable LLM or combination of LLMs for processing the query. These signals may include user-specific attributes, such as age, location, country, region, or browsing history, and runtime conditions, such as news trends, events, or other contextual data. The invention includes a processing algorithm that evaluates these signals and dynamically determines the LLM(s) most appropriate for generating an accurate response. A query module is implemented to analyze the question, associated signals, and user attributes passed as parameters, to infer the context, and select one or more LLMs for processing. The system supports directing queries to multiple LLMs and subsequently comparing their outputs.

The present invention provides a response consolidation mechanism. Once responses are generated by the selected LLM(s), the system evaluates and consolidates these outputs into a unified response using criteria derived from the user's signals and preferences. This ensures the final response is both personalized and contextually enriched. By incorporating dynamic switching of LLMs based on real-time and user-specific signals, the invention improves the adaptability, accuracy, and relevance of responses generated by AI systems. This approach addresses limitations in conventional AI systems that rely solely on the content of a query for processing, without considering external factors or personalized contexts.

Various aspects of the disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated operation, concurrently, or in a manner at least partially overlapping in time.

A computer program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

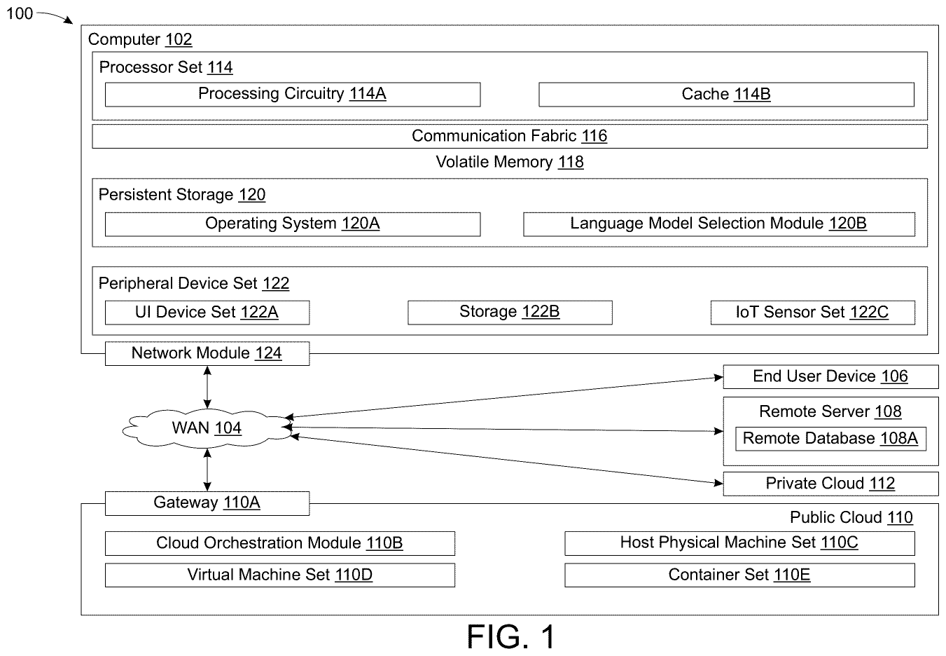

FIG. 1 is a diagram that illustrates a computing environment 100 for dynamically selecting a language model to process queries, in accordance with an embodiment of the disclosure. With reference to FIG. 1, there is shown a computing environment 100 that contains an example of an environment for the execution of at least some of the computer code involved in performing the disclosed methods, such as a language model selection module 120B. In addition to the language model selection module 120B, computing environment 100 includes, for example, a computer 102, a wide area network (WAN) 104, an end-user device (EUD) 106, a remote server 108, a public cloud 110, and a private cloud 112. In this embodiment of the disclosure, the computer 102 includes a processor set 114 (including a processing circuitry 114A and a cache 114B), a communication fabric 116, a volatile memory 118, a persistent storage 120 (including an operating system 120A and the language model selection module 120B, as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or other wearable computer, a mainframe computer, a quantum computer, or any other form of a computer or a mobile device now known or to be developed in the future that is capable of running a program, accessing a network or querying a database, such as a remote database 108A. As is well understood in the art of computer technology, and depending upon the technology, the performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. Computer 102 may be located in a cloud, even though it is not shown in a cloud in FIG. 1. On the other hand, computer 102 is not required to be in a cloud except to any extent as may be affirmatively indicated.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B may be memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computers 102 and thereby effect a computer-implemented method, such that the instructions thus executed will instantiate the methods specified in flowcharts and/or narrative descriptions of computer-implemented methods included in this document (collectively referred to as “the disclosed methods”). These computer-readable program instructions are stored in various types of computer-readable storage media, such as the cache 114B and the other storage media discussed below. The program instructions, and associated data, are accessed by the processor set 114 to control and direct the performance of the disclosed methods. In computing environment 100, at least some of the instructions for performing the disclosed methods may be stored in the dynamic modification of the language model selection module 120B in persistent storage 120.

The communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by a random access, but this is not required unless affirmatively indicated. In computer 102, the volatile memory 118 is located in a single package and is internal to computer 102, but alternatively or additionally, the volatile memory 118 may be distributed over multiple packages and/or located externally with respect to computer 102.

The persistent storage 120 is any form of non-volatile storage for computers that is now known or to be developed in the future. The non-volatility of this storage means that the stored data is maintained regardless of whether power is being supplied to computer 102 and/or directly to the persistent storage 120. The persistent storage 120 may be a read-only memory (ROM), but typically at least a portion of the persistent storage 120 allows the writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in the language model selection module 120B typically includes at least some of the computer code involved in performing the disclosed methods.

The peripheral device set 122 includes the set of peripheral devices of computer 102. Data communication connections between the peripheral devices and the other components of computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A may include components such as a display screen, speaker, microphone, wearable devices (such as goggles and smartwatches), keyboard, mouse, printer, touchpad, game controllers, and haptic devices. Storage 122B is external storage, such as an external hard drive, or insertable storage, such as an SD card. The storage 122B may be persistent and/or volatile. In some embodiments of the disclosure, storage 122B may take the form of a quantum computing storage device for storing data in the form of qubits. In embodiments of the disclosure where computer 102 is required to have a large amount of storage (for example, where computer 102 locally stores and manages a large database) then this storage may be provided by peripheral storage devices designed for storing very large amounts of data, such as a storage area network (SAN) that is shared by multiple, geographically distributed computers. The IoT sensor set 122C is made up of sensors that can be used in Internet of Things applications. For example, one sensor may be a thermometer and another sensor may be a motion detector.

The network module 124 is the collection of computer software, hardware, and firmware that allows computer 102 to communicate with other computers through WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In various embodiments of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the disclosed methods can typically be downloaded to computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments of the disclosure, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates computer 102) and may take any of the forms discussed above in connection with computer 102. The EUD 106 typically receives helpful and useful data from the operations of computer 102. For example, in a hypothetical case where computer 102 is designed to provide a recommendation to an end user, this recommendation would typically be communicated from the network module 124 of computer 102 through WAN 104 to EUD 106. In this way, the EUD 106 can display, or otherwise present recommendations to an end user. In some embodiments of the disclosure, EUD 106 may be a client device, such as a thin client, heavy client, mainframe computer, desktop computer, and so on.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data may be provided to the computer 102 from the remote database 108A of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. Virtual computing environments (VCEs) typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. Gateway 110A is the collection of computer software, hardware, and firmware that allows public cloud 110 to communicate through WAN 104.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to public cloud 110, except that the computing resources are only available for use by a single enterprise. While the private cloud 112 is depicted as being in communication with the WAN 104, in various embodiments of the disclosure, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a larger hybrid cloud.

In operation, the present computer 102 provides dynamic switching between language models such as large language models (LLMs) based on user-provided questions and additional contextual signals. These signals, which include attributes such as age, location, country, browsing history, and real-time runtime conditions like news trends and events, are securely collected after obtaining user consent. Depending on the environment, signals may be derived from user profiles in registration-based services or through real-time updates from external sources. The system ensures privacy and data security by employing secure, encrypted APIs or intra-module communication for transmitting and processing these signals, enabling dynamic decision-making without compromising user confidentiality.

Computer 102 employs a decision-making module that integrates machine learning models, predefined rule sets, and user preferences to determine the most appropriate LLM or combination of LLMs for query processing. Machine learning models are trained on user interactions to improve accuracy over time, while real-time data such as current news trends augment the decision-making process. Predefined rules act as fallback mechanisms, ensuring the system operates effectively even in dynamic and rapidly changing scenarios. This combination of inputs allows the system to optimize LLM selection for contextually relevant responses, addressing biases and enhancing overall performance.

To generate a consolidated response, the system processes outputs from multiple LLMs through a response pre-processor module. This module applies weights or rankings to individual responses based on user-specific signals and parameters, ensuring the selection of the most appropriate output. In cases where responses from different LLMs have equal rankings, the system integrates these outputs into a unified answer. This conflict-resolution mechanism ensures consistency and accuracy, while the final response is presented to the user in a clear and concise format, enhancing user experience.

The computer 102 also incorporates runtime signals, such as real-time news trends and events, by querying both publicly available and private knowledge sources. Keywords extracted from this data are integrated into the query processing pipeline as additional signals. These signals dynamically update the decision-making process, ensuring that the selected LLM remains relevant to the user's query in rapidly evolving scenarios. By leveraging these capabilities, the system adapts to changing contexts and provides personalized, accurate, and contextually enriched responses.

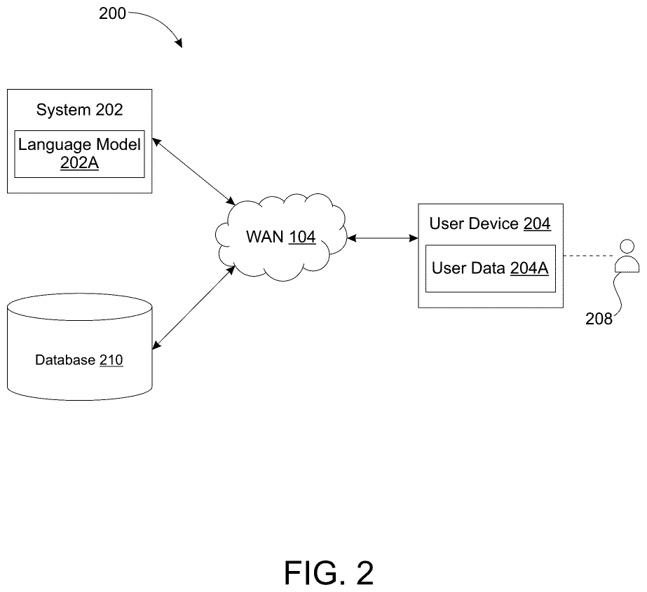

FIG. 2 is a diagram that illustrates a network environment 200 for dynamically selecting a language model to process queries, in accordance with an embodiment of the disclosure. FIG. 2 is explained in conjunction with elements from FIG. 1. With reference to FIG. 2, there is shown a diagram of the network environment 200. The network environment 200 includes a computer system (hereinafter referred to as system 202), and a user device 204. The system 202 further includes a language model 202A. There is further shown a database 210. The network environment 200 further includes entity 208 associated with the user device 204. Examples of entity 208 include but are not limited to a user who has queries and uses the computer related to the present invention. The network environment 200 further includes the WAN 104 of FIG. 1. In an embodiment of the disclosure, the user device 204 may be an exemplary embodiment of the EUD 106. Similarly, the computer system 202 may be an embodiment of the computer 102 in FIG. 1.

The system 202 may include suitable logic, circuitry, interfaces, and/or code that may be configured for dynamically selecting a language model to process queries. System 202 is configured to receive a query, a set of signals (or indicators), and a set of parameters associated with the query. The signals may include, but are not limited to, user-specific attributes such as age, location, past browsing history, and user profile data, as well as real-time contextual information such as news trends or events. In an embodiment, these signals are collected using one or more secure APIs or intra-module calls and are transmitted using encryption protocols to ensure data security and maintain user privacy. System 202 is further configured to obtain user consent before collecting the set of signals and any additional signals, thereby restricting the use of sensitive user data and ensuring compliance with privacy regulations. Examples of the ‘query’ or ‘queries’ include but are not limited to a user query and a machine-generated query. User-generated queries are queries created directly by users, often inputted into a system through various interfaces such as search engines, voice commands, or application forms. Machine-generated queries are queries automatically generated by a computer or computing device without direct user intervention. Such queries may be triggered by algorithms, system operations, or pre-programmed instructions. For instance, a machine learning model might generate a query to retrieve data for training purposes, or a database system might execute an internal query to update or retrieve records based on predefined conditions. In an embodiment, signals refer to a set of instructions or actions that need to be performed. In an exemplary embodiment, system 200 receives signals indicative of specific actions to be executed. For instance, the signals provide system 202 with instructions on how to process or handle user-specific attributes.

In an exemplary embodiment, parameters are specific data points or values associated with a query that the system uses for processing. These can include both user-specific information (e.g., attributes) and contextual data that provide more detail about the query. In an embodiment, parameters may be a subset of the signals. For example, keywords extracted from the query, location, and other related query-specific details. In an exemplary embodiment, indicators may include the frequency of specific keyword use, browsing patterns, or location-based activity trends. User attributes are static or dynamic characteristics or properties associated with a user. These user attributes provide personal or contextual information about the user and are often used to personalize responses or improve relevance in processing queries. For example, age, location, past browsing history, and user profile data. In an exemplary embodiment, additional signals refer to supplementary pieces of information that enhance or complement the primary signals. These additional signals often include real-time or contextual data, such as trending news or events, and extracted keywords, which are used to refine the system's decision-making process. For example, keywords related to the query, news trends, or current events are integrated as part of the decision-making process.

System 202 is configured to determine, based on the query and the set of signals, which of a set of language models (large language models (LLMs)) is suitable for generating a response. The determination process is supported by a decision-making module within System 202 that employs a combination of predefined rule sets, machine learning models, and real-time runtime signals. Predefined rule sets can be customized based on user preferences or organizational requirements. Additionally, the machine learning models are trained on historical user interaction data, enabling the system to adaptively refine its selection of LLMs over time. Runtime signals such as real-time news trends and events are dynamically updated within System 202 to ensure the relevance of the selected LLMs in rapidly changing scenarios.

System 202 is configured to select at least one large language model from the determined set of language models based on the predefined rules, machine learning models, and real-time signals. The selected LLM is queried to generate a set of responses specific to the query. System 202 is further configured to apply a weightage to the set of responses based on the set of signals. For example, responses may be prioritized based on user attributes or contextual parameters derived from the signals. In an embodiment, weightage refers to the relative importance or significance assigned to various factors when ranking responses. The system 202 evaluates each response against certain criteria, such as user-specific parameters (e.g., preferences, past behavior) and real-time signals (e.g., current trends or contextual relevance). A numerical value or weight is assigned to each criterion to indicate its importance in determining the relevance of a response. Further, the weights are applied to the responses, and a cumulative score is calculated for each response. System 202 uses this score to rank the responses, with higher-scoring responses being more relevant or aligned with the user's context. In cases where multiple LLMs produce responses with identical rankings, system 202 combines these responses into a unified output. A response pre-processor module is configured to resolve inconsistencies among the responses to generate a consolidated response, which is subsequently output to the user.

System 202 is also configured to query external or internal data sources, including real-time news feeds, knowledge databases, and closed-network systems, to retrieve supplementary information related to the query. The retrieved information is processed to extract a set of keywords, which are then integrated as additional signals into the decision-making process. This integration enhances the contextual accuracy and relevance of the response generation process. Furthermore, system 202 is configured to evaluate biases and performance metrics of the selected LLMs and adjust the selection criteria as necessary. By filtering real-time data based on query-related keywords or user profile attributes, system 202 ensures that responses remain contextually accurate and tailored to the user's needs. Additionally, system 202 is configured to receive user feedback or clarification statements on the consolidated response, allowing for iterative refinement of the response-generation process.

In an embodiment, the examples of the computer system 202 may include, but are not limited to, a server, a computing device, a virtual computing device, a mainframe machine, a computer workstation, a smartphone, a cellular phone, a mobile phone, a gaming device, or a consumer electronic (CE) device.

The user device 204 may include suitable logic, circuitry, interfaces, and/or code that may enable users to interact with the system 202. Examples of the user device 204 may include, but are not limited to, a computing device, a mainframe machine, a server, a computer work-station, a smartphone, a cellular phone, a mobile phone, a gaming device, a consumer electronic (CE) device, a head-mounted device, a Virtual Reality (VR) Headset, an Augmented Reality (AR) Device, a Mixed Reality (MR) Device, a Projection-based System, and/or any other device with computer vision display capabilities.

The display screen may include suitable logic, circuitry, and interfaces that may be configured to render an output generated by the system 202. In some embodiments of the disclosure, the display screen may be an external display device associated with the user device 204. The display screen may be a touch screen which may enable entity 208 to interact via the display screen. The touch screen may be at least one of a resistive touch screen, a capacitive touch screen, or a thermal touch screen. In accordance with an embodiment of the disclosure, the display screen may refer to a display screen of a head-mounted device (HMD), a smart-glass device, a see-through display, a projection-based display, an electrochromic display, or a transparent display. In some embodiments of the disclosure, the display screen may be realized through several known technologies such as, but are not limited to, at least one of a liquid Crystal Display (LCD) display, a Light Emitting Diode (LED) display, a plasma display, or an Organic LED (OLED) display technology.

In an embodiment, the language model 202A may correspond to a computer-based system or software that exhibits characteristics commonly associated with human intelligence. The language model 202A may be designed to perform tasks that typically require human intelligence, such as problem-solving, learning, reasoning, perception, understanding natural language, and decision-making. AI systems can range from simple rule-based programs to sophisticated, self-learning systems.

The language model 202A may be a sophisticated piece of software that leverages natural language processing (NLP) and machine learning processes to understand, generate, and manipulate human language. For example, the language model 202A may correspond to a large language model (LLM) model that is specifically designed for tasks related to language understanding and generation on a large scale. Certain characteristics of the LLM model may include, but are not limited to, natural language understanding, text generation, semantic understanding, transfer learning, multimodal capabilities, continuous learning, and user interaction. For example, the LLM model for language processing may be implemented using GPT, Bidirectional Encoder Representations from Transformers (BERT), and the like.

Further, the LLM may be a type of ML model specifically designed to understand, generate, and manipulate human language on a large scale. LLMs may leverage machine learning processes, particularly those based on deep learning architectures, to process and comprehend natural language. LLMs have gained prominence for their ability to perform a wide range of language-related tasks, including natural language understanding, text generation, translation, summarization, and more. Typically, LLMs may be characterized by a vast number of parameters, often ranging from tens of millions to billions. The large parameter count allows these models to capture complex language patterns and relationships during training.

In an example, the LLMs may be considered to be built on transformer architecture, however, this should not be construed as a limitation. For example, the transformer architecture effectively captures long-range dependencies and contextual information in language. Moreover, the transformer architecture may use attention mechanisms to weigh the significance of different parts of an input sequence. In addition, the LLMs may employ bidirectional processing, allowing the models to consider context from both directions when analyzing a sequence of words. This bidirectional approach enhances the model's understanding of the context in which words appear. For example, the LLMs may generate contextual representations of words, meaning that the representation of a word is influenced by its surrounding context. This enables the model to capture the meaning of words in different contexts.

In an embodiment, the database 210 corresponds to an organized collection of data that may be stored and accessed electronically from a computer system (such as the system 202). The database 210 is configured to manage, store, retrieve, and update data efficiently. In an exemplary implementation, the structure of the database 210 typically involves tables, records, and fields that can be managed through various database management systems (DBMS). Examples of database 210 include but are not limited to, a relational database, a Non-Structured Query Language (SQL) database, a hierarchical database, a network database, a transactional database, a data warehouse, and a distributed database. In an embodiment, the database 210 is configured to store the audio data 204A associated with the user device 204 which may include the operating system data, software application data, and software application version data. Further, database 210 stores instructional interactions that may be used to train the language model 202A.

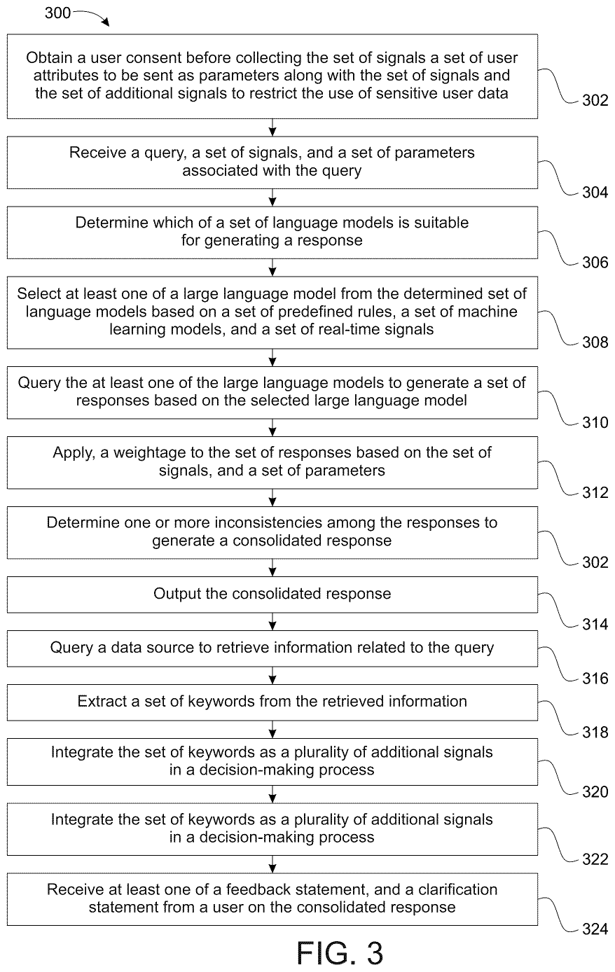

FIG. 3 illustrates a flowchart 300 that illustrates an exemplary computer-implemented method for dynamically selecting a language model to process queries, in accordance with an embodiment of the disclosure. FIG. 3 is explained in conjunction with elements of FIG. 1, and FIG. 2. With reference to FIG. 3, there is shown a flowchart 300. The operations of the exemplary method may be executed by any computing system, for example, by the computer 102 of FIG. 1 or the system 202 of FIG. 2. The operations of the flowchart 300 may start at 302. To ensure user privacy, at step 302, explicit consent is obtained before collecting signals and additional signals, complying with privacy regulations like GDPR or CCPA. Users are informed about the type and purpose of the data being collected. At step 304, a query and a set of associated signals, such as user-specific attributes (e.g., age, location, or browsing history) and runtime indicators (e.g., news trends or events), are received through secure transmission protocols. At step 306, the system determines which LLMs are suitable for generating a response based on these inputs. This determination involves evaluating the query and signals, parameters using predefined rules, machine learning models, and contextual information to identify the most relevant model(s).

At step 308, at least one LLM is selected from the identified set of models based on a combination of predefined rules, machine learning models, and real-time signals, ensuring contextual relevance and computational efficiency. Subsequently, at step 310, the selected LLM(s) is queried to generate multiple potential responses. These responses are then processed in step 312, where weightages are applied to rank each response based on user-specific parameters and runtime signals to prioritize those aligning most closely with the user's context.

At step 314, the system identifies any inconsistencies among the responses and applies resolution techniques to generate a unified and contextually accurate consolidated response. This response is then outputted to the user at step 316 via the interface in an appropriate format, such as text or voice. Additionally, at step 318, the system queries external or internal data sources (e.g., knowledge graphs or news databases) to retrieve information relevant to the query. Using natural language processing (NLP) techniques, a set of keywords is extracted from the retrieved data at step 320. These keywords are integrated as additional signals at step 322, enriching the decision-making process with supplementary contextual information.

Finally, at step 324, users can provide feedback or request clarifications on the consolidated response, enabling the system to refine future outputs. The feedback loop allows the system to update weightage criteria and improve personalization and response accuracy. This comprehensive process ensures dynamic, context-aware query processing and personalized user interaction.

According to one or more embodiments of the disclosure, a computer program product for dynamically selecting a language model to process one or more queries is described. The computer program product includes a computer-readable storage media having program instructions stored on the computer-readable storage media to perform operations. The operations include receiving the one or more queries, a set of signals, and a set of parameters associated with the one or more queries. The operations further include based on the query, the set of signals, and the set of parameters determining which of a set of language models is suitable for generating a response. The operations include selecting at least one of a large language model from the determined set of language models based on a set of predefined rules, a set of machine learning models, and a set of real-time signals. The operations include querying at least one of the large language models to generate a set of responses based on the selected large language model. The operations further include applying a weightage to the set of responses based on the set of signals and the set of parameters. The operations further include determining one or more inconsistencies among the responses to generate a consolidated response. The operations further include outputting the consolidated response.

Thus, the present system and method enhance the effectiveness and functionality of large language models (LLMs) in query processing. Accordingly, one advantage of the present invention is that it provides enhanced personalization by incorporating additional user-specific parameters passed as attributes such as age, location, browsing history, and runtime conditions like regional news trends as part of signals. These contextual signals ensure that the responses generated are highly tailored to the user's unique preferences and environment, resulting in improved user satisfaction and engagement. Accordingly, another advantage of the present invention is that it provides dynamic optimization of LLM utilization. Accordingly, another advantage of the present invention is that it employs a dynamic switching mechanism that selects the most suitable LLM or combination of LLMs based on predefined rules, machine learning models, and real-time signals. This approach ensures optimal performance by leveraging the strengths of specific LLMs for different query contexts, thereby reducing computational overhead and enhancing response accuracy. Accordingly, another advantage of the present invention is that it improves accuracy and consistency in responses. By directing queries to one or more LLMs, comparing their outputs, and generating a consolidated response, the system minimizes inconsistencies and conflicts. The application of weighting and ranking mechanisms further refines the outputs, ensuring that the responses are accurate, coherent, and contextually enriched for the user. Accordingly, one of the advantages of the present invention is that it addresses how multiple LLMs can collaborate dynamically during query processing to optimize performance, cost, and accuracy.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a computer, a query, a set of signals, and a set of parameters associated with the query;
based on the query, the set of signals and the set of parameters, determining, by the computer, which of a set of language models is suitable for generating a response;
selecting, by the computer, at least one of a large language model from the determined set of language models based on a set of predefined rules, a set of machine learning models, and a set of real-time signals;
querying, by the computer, the at least one of the large language models to generate a set of responses based on the selected large language model;
applying, by the computer, a weightage to the set of responses based on the set of signals and the set of parameters;
determining, by the computer, one or more inconsistencies among the responses to generate a consolidated response; and
outputting, by the computer, the consolidated response.

2. The computer-implemented method of claim 1, further comprising:
querying, by the computer, a data source to retrieve information related to the query;
extracting, by the computer, a set of keywords from the retrieved information; and
integrating, by the computer, the set of keywords as a plurality of additional signals in a decision-making process.

3. The computer-implemented method of claim 1, further comprising:
obtaining, by the computer, a user consent before collecting a set of user attributes to be sent as parameters along with the set of signals and the set of additional signals to restrict the use of sensitive user data.

4. The computer-implemented method of claim 1, further comprising:
receiving, by the computer, at least one of a feedback statement, and a clarification statement from a user on the consolidated response.

5. The computer-implemented method of claim 1, wherein the weightage assigns higher rankings to the responses aligned with a set of user-specific parameters.

6. A computer system, comprising:
a processor set;
one or more computer-readable storage media; and
program instructions stored on the one or more computer-readable storage media, the program instructions executable by the processor set to cause the processor set to:
receive a query, a set of signals, and a set of parameters associated with the query;
based on the query, the set of signals and the set of parameters, determine which of a set of language models is suitable for generating a response;
select at least one of a large language model from the determined set of language models based on a set of predefined rules, a set of machine learning models, and a set of real-time signals;
query at least one of the large language models to generate a set of responses based on the selected large language model;
apply a weightage to the set of responses based on the set of signals and the set of parameters;
determine one or more inconsistencies among the responses to generate a consolidated response; and
output the consolidated response.

7. The computer system of claim 6, wherein the program instructions further cause the processor set to:
query a data source to retrieve information related to the query;
extract a set of keywords from the retrieved information; and
integrate the set of keywords as a plurality of additional signals in a decision-making process.

8. The computer system of claim 6, wherein the program instructions further cause the processor set to:
obtain a user consent before collecting a set of user attributes to be sent along with the set of signals and the set of additional signals to restrict the use of sensitive user data.

9. The computer system of claim 6, wherein the program instructions further cause the processor set to:
receive at least one of a feedback statement and a clarification statement from a user on the consolidated response.

10. The computer system of claim 6, wherein the weightage assigns higher rankings to the responses aligned with a set of user-specific parameters.

11. A computer program product for dynamically selecting a language model to process one or more queries, the computer program product comprising:
one or more computer-readable storage media; and
program instructions stored on the one or more computer-readable storage media to perform operations comprising:
receiving the one or more queries, a set of signals, and a set of parameters associated with the one or more queries;
based on the query, the set of signals, and the set of parameters determining which of a set of language models is suitable for generating a response;
selecting at least one of a large language model from the determined set of language models based on a set of predefined rules, a set of machine learning models, and a set of real-time signals;
querying the at least one of the large language models to generate a set of responses based on the selected large language model;
applying a weightage to the set of responses based on the set of signals and the set of parameters;
determining one or more inconsistencies among the responses to generate a consolidated response; and
outputting the consolidated response.
